(19) United States
(12) Patent Application Publication
(10) Pub. No.: US 2026/0099270 A1
(43) Pub. Date: Apr. 9, 2026

(54) RUGGEDIZED COMPUTATIONAL STORAGE DEVICE

(71) Applicant: Seagate Technology LLC, Fremont, CA (US)

(72) Inventors: Hemantkumar Vitthalrao Mane, Pune (IN); Nahoosh Hemchandra Mandlik, Mumbai (IN); Jon D. Trantham, Chanhassen, MN (US); Nikhil Vasanthakumar, Pune (IN)

(21) Appl. No.: 18/897,811

(22) Filed: Sep. 26, 2024

(51) Int. Cl. G06F 3/06

(52) U.S. Cl. CPC G06F 3/0658; G06F 3/0619; G06F 3/0679; G06F 3/0689

(57) ABSTRACT

A data storage system for use in a high radiation environment includes an array of storage drives. Each of the storage drives includes a non-radiation-hardened drive controller, a non-radiation-hardened non-volatile storage medium, and a non-radiation-hardened volatile memory. A radiation-hardened storage controller is coupled to the array, the radiation-hardened storage controller provides host access to the array. One or more compute cores are configured to locally perform at least one operation on data stored on one or both of the non-volatile storage medium and the volatile memory based on a computational storage function received from the host.

### SUMMARY

A data storage system for use in a high radiation environment includes an array of storage drives. Each of the storage drives includes a non-radiation-hardened drive controller, a non-radiation-hardened non-volatile storage medium, and a non-radiation-hardened volatile memory. A radiation-hardened storage controller is coupled to the array, the radiation-hardened storage controller provides host access to the array. One or more compute cores are configured to locally perform at least one operation on data stored on one or both of the non-volatile storage medium and the volatile memory based on a computational storage function received from the host.

A data storage system for use in a high radiation environment includes a controller board comprising a radiation-hardened storage controller. A storage array board is coupled to the controller board. The storage array board includes an array of storage drives. Each of the storage drives includes a non-radiation-hardened drive controller, a non-radiation-hardened, NAND flash medium coupled to the controller, and a non-radiation-hardened volatile memory coupled to the controller. One or both of the controller board and the storage array board includes one or more compute cores configured to locally perform at least one operation on data stored on one or both of the array of storage derives and the volatile memory based on a computational storage function received from a host.

These and other features and aspects of various embodiments may be understood in view of the following detailed discussion and accompanying drawings.

### BRIEF DESCRIPTION OF THE DRAWINGS

The discussion below makes reference to the following figures, wherein the same reference number may be used to identify the similar/same component in multiple figures.

FIG. 1 is a diagram showing applications for a radiation-hardened storage device according to an example embodiment;

FIG. 2 is a diagram of a radiation-hardened storage according to an example embodiment; and

FIGS. 3A-4B are schematic diagrams of a radiation-hardened storage according to example embodiments.

### DETAILED DESCRIPTION

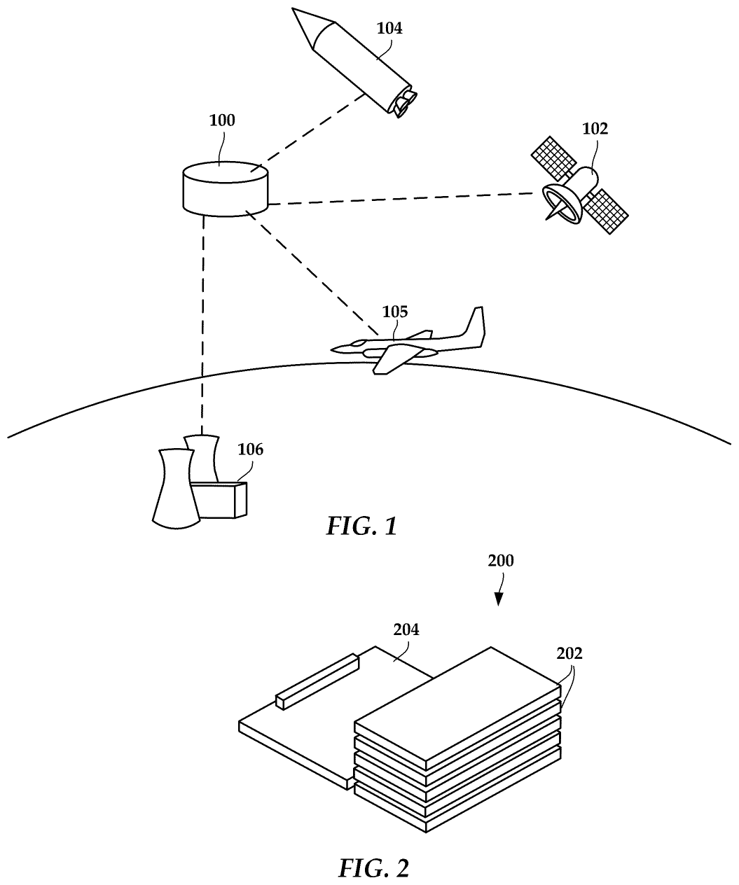

Examples described herein relate to the design of computational storage system using high-capacity high-performance (e.g., NAND flash) off-the-shelf commercial data storage components along with in-data compute using configurable compute units that is also reliable under conditions of increased radiation. In FIG. 1, a diagram shows an example of environments in which such a data storage system 100 may be employed. For example, a significant increase in cosmic radiation is well known to occur during space flight, such as in Low-Earth-Orbit (LEO) spacecraft 102. There has recently been a proliferation of LEO satellites, thanks largely to a variety of new commercial rockets with innovative satellite delivery techniques. The desire for high-capacity data storage in LEO satellites has led to using commercial (terrestrial) products in these applications. These products are generally not designed with the extreme radiation and temperature environments of LEO in mind and suffer from lack of reliability in this application. Recently, there are increasing efforts on deploying these terrestrial products for LEO space application by adding virtual shields around them to improve the operational reliability. These drives generally employ standard data flow models between physically separate host and storage which is similar to most terrestrial applications.

Other types of aerospace vehicles may also benefit from a radiation resistant mass storage device, such as deep space craft 104, high altitude aircraft 105, etc. Also, while aerospace craft are described as a beneficiary of this technology, the storage systems may be used in any high-radiation environment, such as terrestrial nuclear power plants 106, nuclear waste facilities, nuclear cleanup sites, nuclear test sites, etc. Robust “space-grade” data storage products, designed for safety-critical applications are available, however these products are very expensive and often lack the performance and storage capacity of their commercial counterparts.

With an increase in the deployment of LEO satellites there is a corresponding increase in diversified applications which are being deployed in space. These applications often perform sensor fusion, image processing, and/or artificial intelligence (AI) analytics on fused data in orbit. These applications generally perform many data transfers between an on satellite host and a storage system. Transferring data between the host and the storage system is typically not power efficient. The host and the storage system use separate modules and high-speed interconnections, which are not weight-efficient, power-efficient, or as reliable as is possible with an integrated module.

The space industry has very stringent Size, Weight and Power (SWaP) requirements without compromising on the reliability of the product. As these parameters are interdependent, it may be useful to find a preferred balance between these parameters. Typically, increased power requirements translate into increased size which means increased weight and cost. Similarly, to get more reliable performance, more power may be used which translates into better conduction cooling requirements which again increases weight and size.

Examples described herein involve a new aerospace data storage device, designed with features making it more robust, efficient, and reliable for LEO and similar environments. In one or more embodiments, rad-tolerant/rad-hard components are used selectively (e.g., where critical and/or inexpensive) and error detection and mitigation techniques are used for radiation-induced events, such as on expensive/unavoidable soft components, to minimize their impact. The data storage system includes in-storage compute capabilities to perform near data compute to create power efficient space deployment.

In FIG. 2, a diagram illustrates an example of a data storage system 200 for use in a high radiation environment according to an example embodiment. The system includes an array of drives 202 each comprising non-radiation-hardened controllers and non-radiation-hardened, non-volatile, solid-state storage media. The storage media may include NAND flash memory, resistive random access memory (RRAM), magnetoresistive random access memory (MRAM), phase change memory (PCM), ferroelectric RAM (FeRAM), magnetic disks, etc. Note that the drives 202 are shown here as physically separate units, however some or all of the drives 202 may all be integrated into a single circuit board in some embodiments.

Generally, the drives 202 include circuitry that enables addressing the storage units of the media (e.g., pages, sectors) for purposes of reading and writing, and may include other circuits such as power conditioning, integrated error checking/recovery, garbage collection, wear leveling, etc. The drives 202 may include an industry standard common storage access interface, often referred to as a host interface. Examples of host interfaces include serial ATA (SATA), small computer system interface (SCSI), non-volatile memory express (NVMe), peripheral component interconnect express (PCIe), Compute Express Link (CXL) etc. The drives 202 may also include an industry standard physical form factor such as M.2, PCIe, 2.5 inch disk drive, etc., or may include off-the-shelf drive components integrated into one or more custom circuit boards (e.g., with more than one drive on each board). In one or more embodiments, the drives 202 may include hard disk drives (HDDs) with magnetic disks as a storage media instead of or in addition to a solid-state storage media (e.g., hybrid drive).

A radiation-hardened array controller 204 is coupled to the array of drives 202. The controller 204 can be hardened by being manufactured with large process nodes, manufacturing on insulating and/or large bandgap substrates, use of bipolar devices, adding shielding, etc. The radiation-hardened drive controller 204 provides failure-resistant data redundancy among the drives 202 of the array. The radiation-hardened drive controller 204 provides access to the array, e.g., to a host computer (not shown). In such a case, the array may be presented as one or more virtual volumes using an arrangement such as redundant array of independent disks (RAID). Note that in one or more embodiments, multiple radiation-hardened array controllers 204 may be coupled to the array of drives 202. In such a case, the controllers 204 may operate in a high-availability arrangement, where each controller 204 acts as a primary controller for a first subset of the drives 202 and is coupled as a secondary controller for a second subset of the drives 202. If a primary controller fails, its function is taken over by the secondary controller, which then controls two subsets of the drives 202. Various aspects of a radiation-hardened array controller may be described in more detail in U.S. Pat. No. 11,989,428, which is incorporated by reference herein in its entirety.

According to various examples described herein one or more of the drives have computational storage capabilities to improve power efficiency and performance of the overall system for use in non-terrestrial systems. While examples described herein are generally described as being used in non-terrestrial systems, it is to be understood that the systems described herein may be used in terrestrial systems.

Using a computational storage device avoids extra data transfers, typically from SSDs through field programmable gate arrays (FPGAs) and/or controllers and PCIe interfaces to host main memory for processing. In examples described herein, the host can deploy computational-storage-function (CSF) statically or dynamically on to, for example, compute-cores available within the computational storage drive. At least some host operations can be performed near the stored data. The host instructs the computational storage device on operations to perform on the data and some or all of the processing is done locally within the computational storage drive.

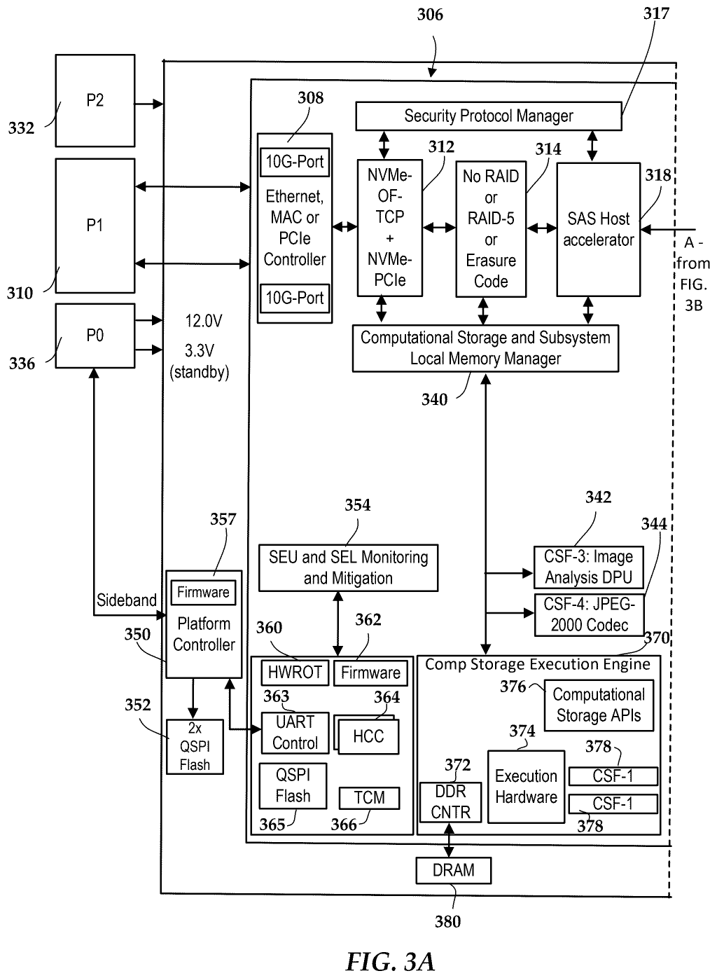

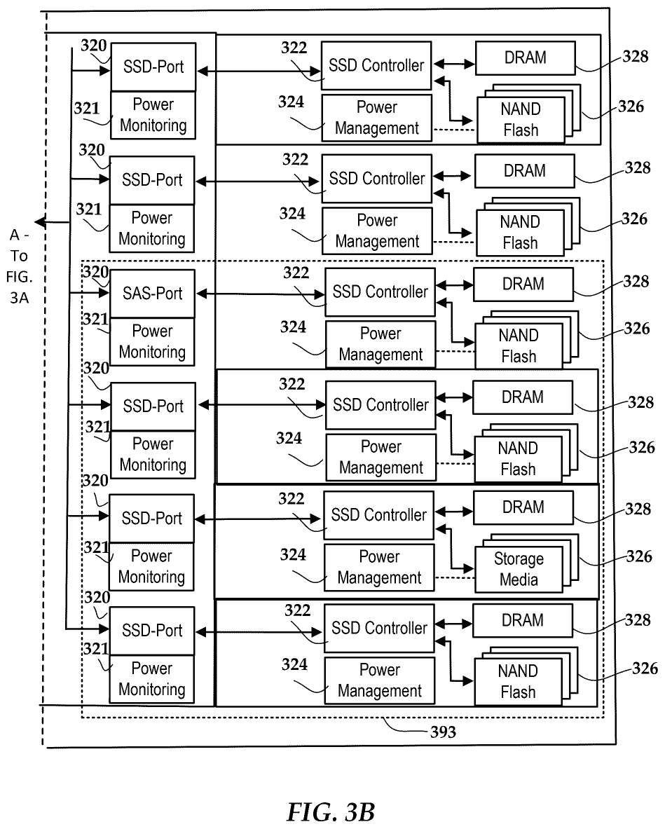

FIGS. 3A and 3B illustrates a schematic diagram that shows details of a storage system 300 in which compute operations are performed within the storage RAID controller according to various examples. Compute cores are incorporated within FPGA/ASIC within the RAID controller data path. There can be single or multiple compute cores which can be used. According to various examples, the compute cores will have shared memory in between the storage data path and the compute cores. Data from the storage will be copied from storage devices to this shared memory and then compute operation is performed on this data. Host can get output directly into its main memory or copy this output into storage SSDs to be accessed later. The shared memory may be one or more of DRAM 380 and on-FPGA-SRAM buffer.

A radiation-hardened storage controller 306 is coupled with a host interface (here shown as a 10G Ethernet port 308 or a PCIe link transport with 8 PCIe lanes and NVMe interface 312) that facilitates communication with a host 310, e.g., a compute module. The NVMe interface 312 presents the storage controller 306 to the host 310 as a storage device. Compute namespace and information about individual compute capabilities may happened inline over the NVMe interface 312, for example, by using vendor specific commands.

There are three host interface ports. P0 336, P1 310 and P2 332. P0 336 provides power to the computational storage module, which can be controlled from host. P0 336 may also provide a sideband interface for the host to configure the computational-storage module. P1 310 is the main host interface to the host and P2 332 is an optional interface to host or other subsystems. For example P2 332 may be a backplane interface port available in a VPX standard. P2 332 may be used to add a custom interface based on the application used.

In some examples, the storage controller 306 can use a different host interface to communicate with the host 310, such as SATA, SAS, or networking interface (e.g., Ethernet, fiber optic networking). In the latter case, the radiation-hardened storage controller 306 could also include an embedded processor and memory for running a file system. The filesystem controller structures and organizes data and metadata on the storage array and may be use as a standard filesystem such as new technology file system (NTFS), ext2, ext3, ext4, etc. The radiation-hardened storage controller 306 may also provide a network file system protocol over the networking interface, such as network file system (NFS), server message block (SMB), common Internet file system (CIFS), etc.

The storage controller 306 also includes a host accelerator 318, which connects to drives on the storage array board 304 as a host device. In this way, the storage controller 306 acts as a proxy for the drives on the storage array board 304, as well as managing the distribution of data and parity among the drives, calculating parity based on data, rebuilding data based on parity, etc. These latter functions are represented by RAID logic block 314, which is located between the NVMe target core 312 and NVMe host core 318. A security protocol manager 317 includes a watchdog monitor that monitors the system for hangs. The watchdog monitor may also be physically and electrically separate from the storage controller board 306 in some examples. Additionally, the security protocol manager 317 manages data confidentially by providing key management services and an interface for access control of data stored on media. Data confidentiality partitions (or encrypted data ranges) are exposed to the host and mapped by the RAID controller to the backend devices'encrypted data ranges.

Data transfer may be completely managed by the radiation-resistant computational storage device. according to various examples. For example, the radiation-resistant computational storage device may manage data transfer from NVM memory space 328 to CSF local memory, data transfer from CSF local memory to NVM memory space, data transfer from one CSF local memory to another CSF local memory, and data transfer from CSF local memory to host local memory over NVMe interface.

Examples described herein can support different types of computational storage functions (CSFs). For example both static-CSFs or dynamic-CSFs may be supported. Static CSF is part of device default firmware and may always be available for application use. According to various examples, dynamic CSF is not available as a part of default firmware (or at boot time). An application may have the responsibility to load the CSF dynamically during run time, which means application has to provision resources that are used to load the CSF and then load that CSF function into the computational storage-drive.

Both static-CSFs and dynamic CSFs can be configured or initialized via computational storage APIs implemented over standard or vendor-specific NVMe commands. Both static and dynamic-CSFs are managed by operating system e.g. Linux, Vxworks, etc. within RCSD, i.e. API from host will communicate with local operating system (Local-OS) within RCSD and this local-OS will then communicate with static or dynamic CSFs.

The host accelerator 318 is coupled to a plurality of SSD ports 320. In this example, SSD ports 320 are used, each with 3 PCIe lanes. Each SSD port 320 is associated with a corresponding power monitoring unit 321 that is configured to monitor power to determine if there is a malfunction at the corresponding SSD port 320. Each of the SSD ports 320 connects to a corresponding SSD controller 322 on the storage array board 304. The SSD controller 322 may include a commercial, off the shelf (COTS) controller that is configured to operate with respective NAND flash memory modules 328 and dynamic RAM (DRAM) 326. While the flash memory modules 328, SSD controller 322, and DRAM 326 may be COTS devices, the storage array board 304 may include power management modules 324 that are custom designed or selected to be radiation-hardened or resistant. Additional features of the illustrated system as well as other embodiments are described in greater detail below. The dashed line section 393 represents that the storage function and power monitoring circuit can be on physically separate board or can be on same FPGA board.

Platform controller 450 provides an interface with P0 436 and storage controller 306. The platform controller 350 is coupled to the storage controller 306 via universal asynchronous receiver-transmitter (UART) controller 463. Flash memory 352 is coupled to platform controller 450 and also the computational storage controller 306 via Quad PSI flash bus 365. An integrated and isolated security domain 360 provides Root-of-Trust capabilities and support security services for the storage solution. These services include platform boot code integrity, secure code update and recovery using A/B copies, a cryptographic device identity, attestation of platform identity and firmware, and limited cryptographic services. At least some of these services are implemented using firmware 357 of the platform controller 350.

Single-event upset (SEU) and single event latch-up (SEL) may be at least partially addressed by an SEU and SEL monitoring and mitigation unit 354. Latch-up is a well-known issue with silicon electronics. It is essentially a type of short circuit within a conventional semiconductor device that can occur during voltage transients, excessive heat, and from radiation. Latch-ups can vary in scope and severity and their effects can grow. Broad latch-ups can lead to overheating and device failure. Smaller latch-ups may occur within a local region of an integrated circuit. In some examples, latch-up status can be monitored by measuring the current draw of components, such as NAND 328 and the SSD controller 322, e.g., via the power management modules 324 which communicate this to the storage controller 306 via general purpose input-output (GPIO) lines and/or system management bus (SMBus). In some examples, SEL and/or SEU status may be detected by a component on the controller board such as the SEU and SEL monitoring and mitigation unit 354.

The current draw of these components will change rapidly on a severe latch-up, and can be caught quickly, however a small latch-up may be hard to distinguish from the normal variation in current draw due to host operation variability. In some examples, the latch-up detector is a system such as a machine-learning algorithm or Kalman filter that factors the drive's/NAND's current workload and temperature into consideration in its detection mechanism to avoid false triggers, yet to not miss smaller triggers. One example would be to have individual current monitors on every NAND component and the controller. In the example design, the current monitoring is more granular, such as over an entire SSD, which may still an improvement over no monitoring at all.

When a latch-up is detected, the recovery is straight-forward: remove power long enough for the latched-up component to cool, typically for a few seconds. During this time, any operations can be deferred or cached until the SSD recovers and is ready for rebuild (if necessary) and normal operation. This removal and re-application of power may be repeatedly performed at regular intervals even if no latch up is detected, e.g., every N hours, where N>1. This can be repeatedly performed at irregular intervals as well, e.g., based on cumulative environmental conditions (e.g., temperature, radiation) and may be limited by a floor function and/or ceiling function to ensure minimum and maximum times between restarts.

Some functionality of the storage controller 306 (e.g., initialization, scheduling, caching, error handling, security) is managed by firmware which runs in microprocessors 362. Hardware control cores (HCC) 364 provide internal control path management and monitoring of individual blocks. The Hardware control cores 364 may communicate health and/or configurations states to the host. Firmware for the Hardware control cores runs from tightly controlled memory (TCM) 366.

The storage controller 306 includes a memory manager 340 that manages the computational storage system. For example, the memory manager 340 may manage data transfers. Various compute function processing blocks may be computed to the memory manager 340. In FIGS. 3A and 3B, an image analysis data processing unit (DPU) 342 that may be used to analyze images in transferred data. A JPEG CODEC processing unit 344 may be used to encode or decode the transferred data. The memory manager 340 is used to control the computational storage execution engine 370.

The computational storage execution engine 370 includes dedicated execution hardware 374 that manages the computational storage execution functions. DRAM 380 is coupled via a dual data rate (DDR) port with error correction code (ECC) 372. An application programming interface (API) 376 enables installation and execution of applications on the computational storage device. The API, enables installation of an application (e.g. an applet or small application) as one or more key-value objects on the data storage drive and enables the execution of the applet within a controlled environment of the computational storage device using one or more computational storage functions (CSFs) 378. According to various examples, more than one API is used.

Note that while the components in FIGS. 3A and 3B specifically call out SSDs that utilize NAND flash for data storage, it will be understood that other media, including magnetic disks, may be substituted for NAND flash, in which case the SSDs may be more generally referred to as a drive or storage drive. Also note that the storage array board 304 may include a combination of non-radiation-hardened COTS circuit components and radiation-hardened circuit components, and all of the components may be attached/soldered to a single board. Nonetheless, for the purpose of the present disclosure, a collection of components (e.g., SSD controller 322, DRAM 326, NAND flash 328) coupled to each root port 320 may considered a separate storage drive for purposes of this disclosure. The power management modules 324 may be considered part of the storage drives or separate from the storage drives depending on the implementation.

By utilizing multiple SSDs in parallel, with RAID redundancy (or other type of failure resistant data redundancy arrangement) and putting them behind a hardened RAID controller 306 that is robust against the space radiation environment, the storage system is no longer dependent upon the failure rate of a single non-hardened device. RAID controllers are small enough to fit in today's RAD-hard/RAD-tolerant FPGAs. By hardening the RAID controller 306, not the SSD controller 322, the cost of the product can be reduced, but still have acceptable reliability.

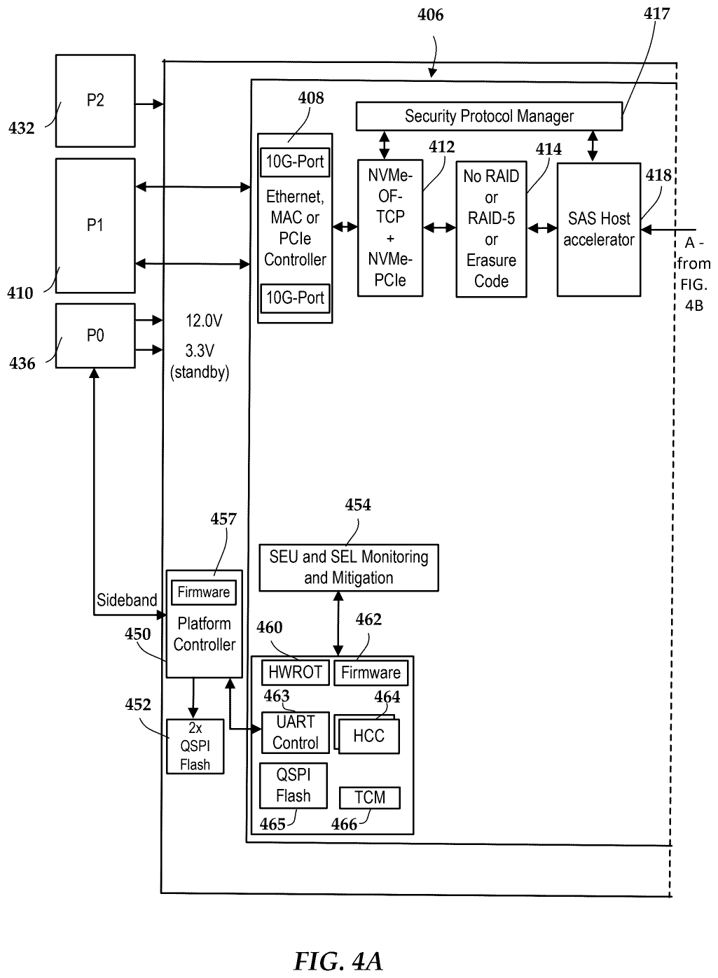

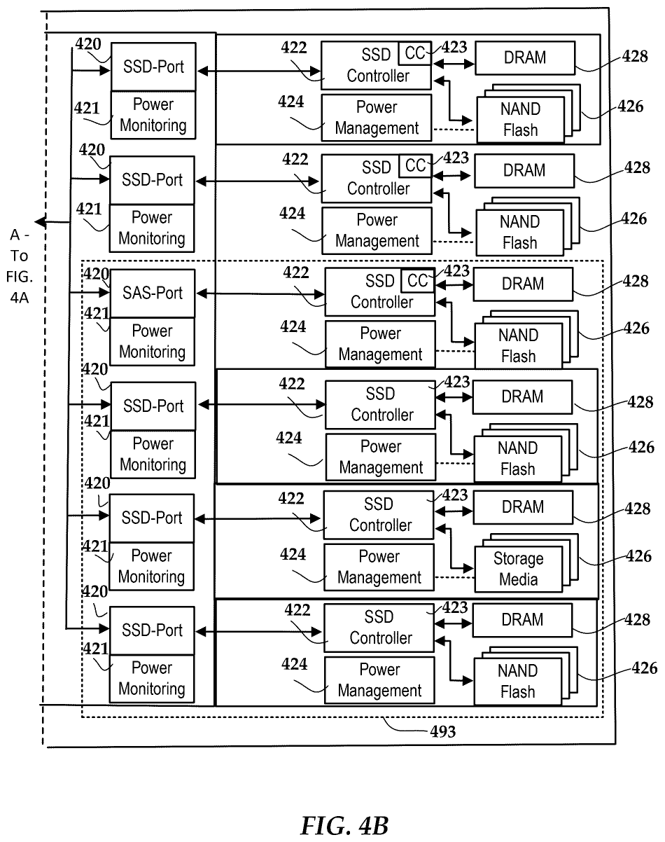

The redundancy level of the RAID controller can be adjusted for the application. For most general-purpose applications, a RAID-5 controller can be used with three data stripes and one parity stripe as shown in FIGS. 4A and 4B. In this diagram, a hardened RAID controller is coupled to a non-hardened (e.g., COTS) drive array, which uses four SSDs for example. For a higher-reliability design, different RAID and/or erasure codes can be used allowing for multiple back-end failures before loss of storage functionality. For example, a RAID-6 arrangement with two data stripes and two parity stripes can be used for a four drive array, and additional data stripes can be added if more drives are added to the RAID 6 array.

FIGS. 4A and 4B show an example in which each SSD controller 422 includes a compute core 423 according to various examples. These individual compute cores replace the memory manager 340 and computational storage execution engine 370 in the storage controller 306 shown in FIGS. 3A and 3B. Computational storage cores can be implemented in several ways. One way involves using soft microprocessor cores implemented within inline FPGA/ASIC (e.g., soft RISC-V or ARM core). Hard acceleration cores may be implemented within inline FPGA/ASIC (e.g., Video codec or DSP engines). Hard microprocessor cores may be implemented within inline FPGA/ASIC (e.g., multicore ARM or RISC-V). In some examples, hard microprocessor cores are implemented within each individual SSD.

A radiation-hardened storage controller 406 is coupled with a host interface (here shown as a 10G Ethernet port 408 or a PCIe link transport with 8 PCIe lanes and NVMe interface 312) that facilitates communication with a host 410, e.g., a compute module. The NVMe interface 312 presents the storage controller 406 to the host 410 as a storage device. Compute namespace and information about individual compute capabilities may happened inline over the NVMe interface 412, for example, by using vendor specific commands.

There are three host interface ports. P0 436, P1 410 and P2 432. P0 436 provides power to the computational storage module, which can be controlled from host. P0 436 may also provide a sideband interface for the host to configure the computational-storage module. P1 410 is the main host interface to the host and P2 432 is an optional interface to host or other subsystems. For example P2 432 may be a backplane interface port available in a VPX standard. P2 432 may be used to add a custom interface based on the application used.

In some examples, the storage controller 306 can use a different host interface to communicate with the host 410, such as SATA, SAS, or networking interface (e.g., Ethernet, fiber optic networking). In the latter case, the radiation-hardened storage controller 406 could also include an embedded processor and memory for running a file system. The filesystem controller structures and organizes data and metadata on the storage array board 304 and may be use as a standard filesystem such as new technology file system (NTFS), ext2, ext3, ext4, etc. The radiation-hardened storage controller 406 may also provide a network file system protocol over the networking interface, such as network file system (NFS), server message block (SMB), common Internet file system (CIFS), etc.

The storage controller 406 also includes a host accelerator 418, which connects to drives on the storage array as a host device. In this way, the storage controller 306 acts as a proxy for the drives on the storage array, as well as managing the distribution of data and parity among the drives, calculating parity based on data, rebuilding data based on parity, etc. These latter functions are represented by RAID logic block 414, which is located between the NVMe target core 412 and NVMe host core 418. A security protocol manager 417 includes a watchdog monitor that monitors the system for hangs. The watchdog monitor may also be physically and electrically separate from the storage controller board 406 in some examples. Additionally, the security protocol manager 417 manages data confidentially by providing key management services and an interface for access control of data stored on media. Data confidentiality partitions (or encrypted data ranges) are exposed to the host and mapped by the RAID controller to the backend devices'encrypted data ranges.

The host accelerator 418 is coupled to a plurality of SSD ports 420. In this example, SSD ports 420 are used, each with 3 PCIe lanes. Each SSD port 420 is associated with a corresponding power monitoring unit 421 that is configured to monitor power to determine if there is a malfunction at the corresponding SSD port 420. Each of the SSD ports 420 connects to a corresponding SSD controller 422 on the storage array portion. The SSD controller 422 may include a commercial, off the shelf (COTS) controller that is configured to operate with respective NAND flash memory modules 428 and dynamic RAM (DRAM) 426. While the flash memory modules 428, SSD controller 422, and DRAM 426 may be COTS devices, the storage array portion may include power management modules 424 that are custom designed or selected to be radiation-hardened or resistant. Additional features of the illustrated system as well as other embodiments are described in greater detail below. The dashed line section 493 represents that the storage function and power monitoring circuit can be on physically separate board or can be on same FPGA board.

Platform controller 450 provides an interface with P0 436 and storage controller 406. The platform controller 450 is coupled to the storage controller 406 via universal asynchronous receiver-transmitter (UART) controller 363. Flash memory 452 is coupled to platform controller 450 and also the computational storage controller 406 via Quad PSI flash bus 465. An integrated and isolated security domain 460 provides Root-of-Trust capabilities and support security services for the storage solution. These services include platform boot code integrity, secure code update and recovery using A/B copies, a cryptographic device identity, attestation of platform identity and firmware, and limited cryptographic services. At least some of these services are implemented using firmware 457 of the platform controller 450.

Single-event upset (SEU) and single event latch-up (SEL) may be at least partially addressed by an SEU and SEL monitoring and mitigation unit 454. In some examples, latch-up status can be monitored by measuring the current draw of components, such as NAND 428 and the SSD controller 422, e.g., via the power management modules 424 which communicate this to the storage controller 406 via general purpose input-output (GPIO) lines and/or system management bus (SMBus). In some examples, SEL and/or SEU status may be detected by a component on the controller board such as the SEU and SEL monitoring and mitigation unit 454.

Some functionality of the storage controller 406 (e.g., initialization, scheduling, caching, error handling, security) is managed by firmware which runs in microprocessors 462. Hardware control cores 464 provide internal control path management and monitoring of individual blocks. The Hardware control cores 464 may communicate health and/or configurations states to the host. Firmware for the Hardware control cores runs from tightly controlled memory (TCM) 466.

The various embodiments described above may be implemented using circuitry, firmware, and/or software modules that interact to provide particular results. One of skill in the arts can readily implement such described functionality, either at a modular level or as a whole, using knowledge generally known in the art. For example, the flowcharts and control diagrams illustrated herein may be used to create computer-readable instructions/code for execution by a processor. Such instructions may be stored on a non-transitory computer-readable medium and transferred to the processor for execution as is known in the art. The structures and procedures shown above are only a representative example of embodiments that can be used to provide the functions described hereinabove.

Unless otherwise indicated, all numbers expressing feature sizes, amounts, and physical properties used in the specification and claims are to be understood as being modified in all instances by the term “about. ” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g., 1 to 5 includes 1, 1.5, 2, 2.75, 3, 3.80, 3, and 5) and any range within that range.

The foregoing description of the example embodiments has been presented for the purposes of illustration and description. It is not intended to be exhaustive or to limit the embodiments to the precise form disclosed. Many modifications and variations are possible in light of the above teaching. Any or all features of the disclosed embodiments can be applied individually or in any combination are not meant to be limiting, but purely illustrative. It is intended that the scope of the invention be limited not with this detailed description, but rather determined by the claims appended hereto.

What is claimed is:

1. A data storage system for use in a high radiation environment, comprising:
an array of storage drives each comprising a non-radiation-hardened drive controller, a non-radiation-hardened non-volatile storage medium, and a non-radiation-hardened volatile memory;
a radiation-hardened storage controller coupled to the array, the radiation-hardened storage controller providing host access to the array; and
one or more compute cores configured to locally perform at least one operation on data stored on one or both of the non-volatile storage medium and the volatile memory based on a computational storage function received from the host.

2. The data storage system of claim 1, wherein the radiation-hardened storage controller is a radiation-hardened computational storage controller.

3. The data storage system of claim 1, wherein the radiation-hardened storage controller is a radiation-hardened redundant array of independent disk (RAID) storage controller.

4. The data storage system of claim 1, wherein the storage controller is implemented in a radiation-hardened, field programmable gate array (FPGA).

5. The data storage system of claim 1, further comprising one or more radiation-robust power controllers coupled to the drive controllers and the non-volatile storage medium.

6. The data storage system of claim 1, wherein the non-volatile storage medium comprises a solid-state storage media.

7. The data storage system of claim 6, wherein the solid-state storage media comprises NAND flash memory.

8. The data storage system of claim 1, wherein each of the storage drives of the array of storage drives comprises at least one of the one or more compute cores.

9. The data storage system of claim 1, wherein the one or more compute cores are disposed in the radiation-hardened storage controller coupled to the array.

10. The data storage system of claim 9, wherein the compute cores use one or more computational storage functions (CSFs) to locally perform the at least one operation.

11. The data storage system of claim 10, wherein the one or more CSFs comprise one or both of static CSFs and dynamic CSFs.

12. The data storage system of claim 10, wherein the one or more CSFs can be configured or initialized via one or more computational storage application programming interfaces (APIs).

13. The data storage system of claim 1, wherein the storage controller comprises an integrated and isolated security domain that provides root-of-trust capabilities and supports security services for the system.

14. The data storage system of claim 1, further comprising one or more current monitors on each of the storage drives, the one or more current monitors detecting a latch up condition affecting one or both of the drive controllers and the non-volatile storage medium.

15. A data storage system for use in a high radiation environment, comprising:
a controller board comprising a radiation-hardened storage controller; and
a storage array board coupled to the controller board, the storage array board comprising an array of storage drives, each of the storage drives comprising:
a non-radiation-hardened drive controller;
a non-radiation-hardened, NAND flash medium coupled to the controller; and
a non-radiation-hardened volatile memory coupled to the controller;
wherein one or both of the controller board and the storage array board comprises one or more compute cores configured to locally perform at least one operation on data stored on one or both of the array of storage drives and the volatile memory based on a computational storage function received from a host.

16. The data storage system of claim 15, wherein the radiation-hardened storage controller is a radiation-hardened computational storage controller.

17. The data storage system of claim 15, wherein the radiation-hardened storage controller is a radiation-hardened redundant array of independent disk (RAID) storage controller.

18. The data storage system of claim 15, wherein the one or more compute cores are disposed in the radiation-hardened storage controller coupled to the array.

19. The data storage system of claim 18, wherein the compute cores use one or more computational storage functions (CSFs) to locally perform the at least one operation.

20. The data storage system of claim 19, wherein the one or more CSFs comprise one or both of static CSFs and dynamic CSFs.
